(19) United States
(12) Patent Application Publication
(10) Pub. No.: US 2021/0146665 A1
(43) Pub. Date: May 20, 2021

(54) BIODEGRADABLE LAYERED COMPOSITE

(71) Applicant: 3M INNOVATIVE PROPERTIES COMPANY, St. Paul, MN (US)

(72) Inventors: Ignatius A. Kadoma, Cottage Grove, MN (US); Jeffrey A. Chambers, St. Paul, MN (US); Michael D. Romano, Circle Pines, MN (US); Marie E. Vanderlaan, Minneapolis, MN (US)

(21) Appl. No.: 17/048,380

(22) PCT Filed: Mar. 19, 2019
(86) PCT No.: PCT/IB2019/052216

§ 371 Date: Oct. 16, 2020

Related U.S. Application Data
(60) Provisional application No. 62/659,843, filed on Apr. 19, 2018.

(51) Int. Cl. B32B 27/12; B32B 5/02; B32B 27/36; B32B 5/26; B32B 3/26; D04H 1/56; D04H 1/435; A01G 13/02

(52) U.S. Cl. CPC B32B 27/12; D10B 2401/12; B32B 27/36; B32B 5/26; B32B 3/266; D04H 1/56; D04H 1/435; A01G 13/0275; B32B 2307/7163; B32B 2262/0276; B32B 2264/067; B32B 2264/065; B32B 2307/718; B32B 2410/00; B32B 5/022

(57) ABSTRACT

Biodegradable layered composite comprising a first nonwoven biodegradable layer having a first and second major surface, the first nonwoven biodegradable layer comprising biodegradable polymeric melt-blown fibers, and a plurality of particles enmeshed in the biodegradable polymeric melt-blown fibers; and a biodegradable polymer film on at least a portion of the first major surface of the first nonwoven biodegradable layer. Biodegradable layered composite described herein can be used, for example, as biomulch for controlling weed growth and moisture.

### CROSS REFERENCE TO RELATED APPLICATION

This application claims the benefit of U.S. Provisional Patent Application No. 62/659,843, filed Apr. 19, 2018, the disclosure of which is incorporated by reference herein in its entirety.

### BACKGROUND

Film such as polyethylene films are commonly used in agricultural applications such as vegetable production to control weed growth and moisture. Concerns over disposal of petroleum-based plastics, however, have some growers seeking sustainable alternatives. Bioplastic films and spunbond, nonwoven biofabrics have shown potential as mulches in vegetable production field trials (see, e.g., Scientia Horticulturae, 193, 209-217 (2015) and HortTechnology, 26 (2), 148-155, April 2016). Unfortunately, these biomulches can be relatively expensive.

### SUMMARY

In view of the foregoing, we recognize there is a need in the art for less expensive bio-based alternatives for controlling weed growth and moisture.

In one aspect, the present disclosure describes a biodegradable layered composite comprising:

a first nonwoven biodegradable layer having a first and second major surface, the first nonwoven biodegradable layer comprising:
biodegradable polymeric melt-blown fibers, and
a plurality of particles enmeshed in the biodegradable polymeric melt-blown fibers; and

a biodegradable polymer film on at least a portion of the first major surface of the first nonwoven biodegradable layer. In some embodiments, the biodegradable layered composite further comprises a second nonwoven biodegradable layer comprising spunbond fibers on the second major surface of the first nonwoven biodegradable layer.

As used herein, “biodegradable” refers to materials or products that meet the requirements of ASTM D6400-12 (2012), which is the standard used to establish whether materials or products satisfy the requirements for labeling as “compostable in municipal and industrial composting facilities.”

As used herein, “biodegradable layered composites” refer to layered composites made primarily (i.e., at least 50 percent by weight, based on the total weight of the biodegradable layered composite), from a renewable plant source.

As used herein, “enmeshed” refers to particles that are dispersed and physically held in the fibers of a nonwoven biodegradable layer.

As used herein, “melt-blown” refers to making fine fibers by extruding a thermoplastic polymer through a die having at least one hole. As the fibers emerge from the die, they are attenuated by an air stream.

As used herein, “particles” refer to a small piece or individual part. The particles used in embodiments of biodegradable layered composite described herein can remain separate or may be clumped, physically intermesh, electro-statically associated, or otherwise associated to form particulates.

Biodegradable layered composite described herein can be used, for example, as biomulch for controlling weed growth and moisture. The biodegradability of the biodegradable layered composite addresses concerns about the environmental impact associated with polyethylene film mulch removal and disposal. In addition, crop growers can reduce the time and labor associated with removal and disposal. The inclusion of particles in the biodegradable layered composite reduces the overall cost of biofabric-type materials. In some embodiments, the particles can provide additional benefits such as additional moisture retention, enrichment of the soil, and fertilization. In some embodiments, the particles can increase the overall rate of biodegradation of the biodegradable layered composite.

### BRIEF DESCRIPTION OF THE DRAWINGS

FIG. 1 is a cross-sectional view of an exemplary biodegradable layered composite described herein.

FIG. 2 is a cross-sectional view of another exemplary biodegradable layered composite described herein.

FIG. 2A is a top view of the exemplary biodegradable layered composite shown in FIG. 2.

FIG. 3 is a cross-sectional view of another exemplary biodegradable layered composite described herein.

FIG. 3A is a top view of the exemplary biodegradable layered composite shown in FIG. 3.

### DETAILED DESCRIPTION

Referring to FIG. 1, exemplary biodegradable layered composite 100 comprises first nonwoven biodegradable layer 101 having first and second major surface 112, 113, and biodegradable polymer film 120 on at least a portion of first major surface 112 of first nonwoven biodegradable layer 101. Optionally degradable layered composite 100 further comprises second nonwoven biodegradable layer 131 having first and second major surface 132, 133. First nonwoven biodegradable layer 101 comprises biodegradable polymeric melt-blown fibers 102 and plurality of particles 105 enmeshed in biodegradable polymeric melt-blown fibers 102. Optional second nonwoven biodegradable layer 131 comprises spunbond fibers 135 on second major surface 113 of first nonwoven biodegradable layer 101.

The polymeric melt-blown fibers comprise biodegradable materials. In some embodiments, the biodegradable melt-blown fibers comprise at least one of polylactic acid (PLA), polybutylene succinate (PBS), naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).

The nonwoven biodegradable layers can be made by techniques known in the art. For example, the nonwoven biodegradable layer can be formed by methods comprising flowing molten polymer through a plurality of orifices to form filaments; attenuating the filaments into fibers; directing a stream of particles amidst the filaments or fibers; and collecting the fibers and particles as a nonwoven layer. Further, for example, the nonwoven biodegradable layers may be formed by adding particles, particulates, and/or agglomerates or blends of the same, if applicable, to an air stream that attenuates polymeric melt-blown fibers and conveys these fibers to a collector. The particles become enmeshed in a melt-blown fibrous matrix as the fibers contact the particles in the mixed air stream and are collected to form a layer. Similar processes for forming particle-loaded webs (layers) are described, for example, in U.S. Pat. No. 7,828,969 (Eaton et al.), the disclosure of which is hereby incorporated by reference. Relatively high particle loadings (e.g., up to 97% by weight) are possible according to such methods.

In some embodiments, the first nonwoven layer comprises a biodegradable plasticizer. Exemplary biodegradable plasticizers include at least one of a renewable ester, epoxidized soybean oil, or acetyltri-n-butyl citrate. Exemplary biodegradable plasticizers are available, for example, under the trade designations “HALLGREEN R-8010” and “PLASTHALL ESO” from Hallstar Company, Chicago, Ill.; and “CITROFLEX A-4” plasticizer from Vertellus, Indianapolis, Ind. The plasticizer can be incorporated into the melt-blown fiber layer, for example, by techniques known in the art (e.g., using an apparatus generally as shown in FIG. 1 of U.S Pat. Pub. No. US2004/0108611 (Dennis et al.), the disclosure of which is incorporated herein by reference).

In some embodiments, the biodegradable polymeric melt-blown fibers have an average fiber diameter in a range from 1 to 50 (in some embodiments, in a range from 1 to 40, 1 to 30, 1 to 20, 1 to 15, or even 1 to 10) micrometers.

Spunbond fibers are known in the art and refer to fabrics that are produced by depositing extruded, spun filaments onto a collecting belt in a uniform random manner followed by bonding the fibers. The fibers are separated during the layering process by air jets or electrostatic charges. Layers comprising spunbond fibers can be provided by techniques known in the art (e.g., using an apparatus generally as shown in FIG. 1 of U.S. Pat. No. 8,802,002 (Berrigan et al.), the disclosure of which is incorporated herein by reference) and are also commercially available, for example, under the trade designation “INGEO BIOPOLYMER 6202D” (polylactic acid fibers; spunbond scrim, smooth calendar) from NatureWorks LLC, Minnetonka, Minn. Using techniques known in the art, the melt-blown fibers, for example, can be blown onto a spunbonded web, and the resulting articles passed through two calendar rolls.

The particles can comprise any useful filler material. For example, the particles can comprise agricultural and forestry waste such as rice hulls, wood fiber, starch flakes, bug flour, soy meal, alfalfa meal and biochar, or minerals such as gypsum and calcium carbonate. In some embodiments, the particles are biodegradable. In some embodiments, the particles contain nitrogen. Examples of useful nitrogen-containing materials include composted turkey waste, feather meal, and fish meal. In some embodiments, the particles are inorganic particles. For example, the particles can comprise fertilizers, lime, sand, clay, vermiculite or other related soil conditioners and pH modifiers. In some embodiments, the particles comprise a material that provides improved moisture retention and/or accelerates biodegradation of the biofabric and/or provides improved soil fertility.

In some embodiments, the particles have an average particle size in a range from 1 to 2000 (in some embodiments, in a range from 1 to 1000, 1 to 500, 1 to 100, 1 to 75, 1 to 50, 1 to 25, or even 1 to 10) micrometers.

In some embodiments, the particles are present in the biodegradable layered composite in a range from 1 to 85 (in some embodiments, in a range from 10 to 80, 25 to 80, 25 to 75, or even 50 to 60) percent by weight, based on the total weight of the biodegradable layered composite.

In some embodiments, at least 50 (in some embodiments, at least 60, 70, 75, 80, 85, 90, 95, 99, or even at least 100) percent by weight, based on the total weight of particles, of the particles comprise (in some embodiments, comprise at least 50, 60, 70, 75, 80, 85, 90, 95, 99 or even at least 100 percent by weight, based on the total weight of the respective particle) at least one of agricultural waste or forestry waste. In some embodiments, at least 50 (in some embodiments, at least 60, 70, 75, 80, 85, 90, 95, 99, or even at least 100) percent by weight, based on the total weight of particles, of the particles comprise (in some embodiments, comprise at least 50, 60, 70, 75, 80, 85, 90, 95, 99 or even at least 100 percent by weight, based on the total weight of the respective particle) inorganic material. In some embodiments, at least 50 (in some embodiments, at least 60, 70, 75, 80, 85, 90, 95, 99, or even at least 100) percent by weight, based on the total weight of particles, comprise (in some embodiments, comprise at least 50, 60, 70, 75, 80, 85, 90, 95, 99 or even at least 100 percent by weight, based on the total weight of the respective particle) at least one of turkey waste, feather meal, or fish meal. In some embodiments, at least 50 (in some embodiments, at least 60, 70, 75, 80, 85, 90, 95, 99, or even 100) percent by weight, based on the total weight of particles, of the particles contain nitrogen.

In some embodiments, the particles are in a range from 10 US mesh to 12000 US mesh (in some embodiments, in a range from 25 mesh to 35 mesh). In some embodiments, the particles are as small as 80 mesh and as large as 5 mesh.

In some embodiments, the average diameter of the particles is larger than the average diameter of the fibers for particle capture. In some embodiments, the ratio of average particle diameter to average fiber diameter is a range from 160:1 to 5:1 (in some embodiments, in a range from 150:1 to 5:1, 125:1 to 5:1, 100:1 to 5:1, 75:1 to 5:1, 50:1 to 5:1, 25:1 to 5:1, or even 15:1 to 5:1).

In some embodiments, nonwoven biodegradable layers have an average thickness in a range from 10 to 3000 (in some embodiments, in a range from 10 to 2000, 10 to 1000, 10 to 500, 10 to 100, or even 10 to 50) micrometers.

In some embodiments, biodegradable layered composites described herein have a basis weight in a range from 60 g/m² to 300 g/m². The biodegradable layered composite needs to be sufficiently heavy for acting as a weed barrier but is preferably not too heavy for handling by farm workers or machinery.

In some embodiments, the biodegradable polymeric fibers comprise bi-component fibers comprising a core material covered with a sheath, wherein the sheath material (with a lower melting point) melts to bind with other fibers but the core material (with a higher melting point) maintains its shape. In other embodiments, the biodegradable polymeric melt-blown fibers have a homogenous structure. The homogenous structure may consist of one material or a plurality of materials evenly distributed or dispersed within the structure.

The particle loading process is an additional processing step to a standard melt-blown fiber forming process, as disclosed in, for example, U.S. Pat. Pub. No. 2006/0096911 (Brey et al.), the disclosure of which is incorporated herein by reference. Blown microfibers (BMF) are created by a molten polymer entering and flowing through a die, the flow being distributed across the width of the die in the die cavity and the polymer exiting the die through a series of orifices as filaments. In one exemplary embodiment, a heated air stream passes through air manifolds and an air knife assembly adjacent to the series of polymer orifices that form the die exit (tip). This heated air stream can be adjusted for both temperature and velocity to attenuate (draw) the polymer filaments down to the desired fiber diameter. The BMF fibers are conveyed in this turbulent air stream towards a rotating surface where they collect to form a layer.

Desired particles are loaded into a particle hopper where they gravimetrically fill recessed cavities in a feed roll. A rigid or semi-rigid doctor blade, with segmented adjustment zones, forms a controlled gap against the feed roll to restrict the flow out of the hopper. The doctor blade is normally adjusted to contact the surface of the feed roll to limit particulate flow to the volume that resides in the recesses of the feed roll. The feed rate can then be controlled by adjusting the speed that the feed roll turns. A brush roll operates behind the feed roll to remove any residual particulates from the recessed cavities. The particulates fall into a chamber that can be pressurized with compressed air or other sources of pressured gas. This chamber is designed to create an air stream that will convey the particles and cause the particles to mix with the melt-blown fibers being attenuated and conveyed by the air stream exiting the melt-blown die.

By adjusting the pressure in the forced air particulate stream, the velocity distribution of the particles is changed. When very low particle velocity is used, the particles may be diverted by the die air stream and not mix with the fibers. At low particle velocities, the particles may be captured only on the top surface of the layer. As the particle velocity increases, the particles begin to more thoroughly mix with the fibers in the melt-blown air stream and can form a uniform distribution in the collected layer. As the particle velocity continues to increase, the particles partially pass through the melt-blown air stream and are captured in the lower portion of the collected layer. At even higher particle velocities, the particles can totally pass through the melt-blown air stream without being captured in the collected layer.

In some embodiments, the particles are sandwiched between two filament air streams by using two generally vertical, obliquely-disposed dies that project generally opposing streams of filaments toward the collector. Meanwhile, particles pass through the hopper and into a first chute. The particles are gravity fed into the stream of filaments. The mixture of particles and fibers lands against the collector and forms a self-supporting particle-loaded nonwoven layer.

In other exemplary embodiments, the particles are provided using a vibratory feeder, an eductor, or other techniques known to those skilled in the art.

The biodegradable polymer films have a thickness up to 5 micrometers (in some embodiments, up to 4, 3, or even up to 2; in some embodiments, in a range from 0.5 to 1, 0.5 to 1.5, or even 0.5 to 2) micrometers. In some embodiments, the biodegradable polymer films comprise at least 0.5 (in some embodiments, at least 1) percent by weight of the carbon black, based on the total weight of the film.

Exemplary biodegradable polymer films comprise at least one of polylactide (PLA), polybutylene succinate (PBS), naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)). Exemplary biodegradable polymer films are available, for example under the trade designations “BIOPBS FZ91” from PTT MCC Biochem Co., LTD, Bangkok, Thailand; and “INGEO PLA 4060” from NatureWorks, Minnetonka, Minn. In some embodiments, the biodegradable polymer film comprises a biodegradable plasticizer. Exemplary biodegradable plasticizers include at least one of a renewable ester, epoxidized soybean oil, or acetyltri-n-butyl citrate.

In some embodiments, the film comprises carbon black. In some embodiments, the film comprises at least 0.5 (in some embodiments, at least 1) percent by weight of the carbon black, based on the total weight of the film. Including carbon black in the film can increase the opacity of the film.

In some embodiments, the presence of the film in biodegradable layered composites described herein provides a moisture barrier that improves water utilization during drip tape irrigation.

In some embodiments, the film has a plurality of openings. In some embodiments, the openings are present in a range from 0.5 to 2000 (in some embodiments, in a range from 0.5 to 1000, 0.5 to 500, 0.5 to 100, 1 to 50, 1 to 25, or 1 to 10, or even 1 to 5) mm². In some embodiments, the openings have at least one of the following shapes: a circle, a square, a rectangle, a triangle, or an oval. In some embodiments, the openings have an areal density in a range from 10 to 50 (in some embodiments, in a range from 15 to 40) per cm².

In some embodiments, biodegradable layered composites described herein have a length and a width, wherein the film is in the form of sections along the length of the biodegradable layered composite with areas between the sections that are free of the film.

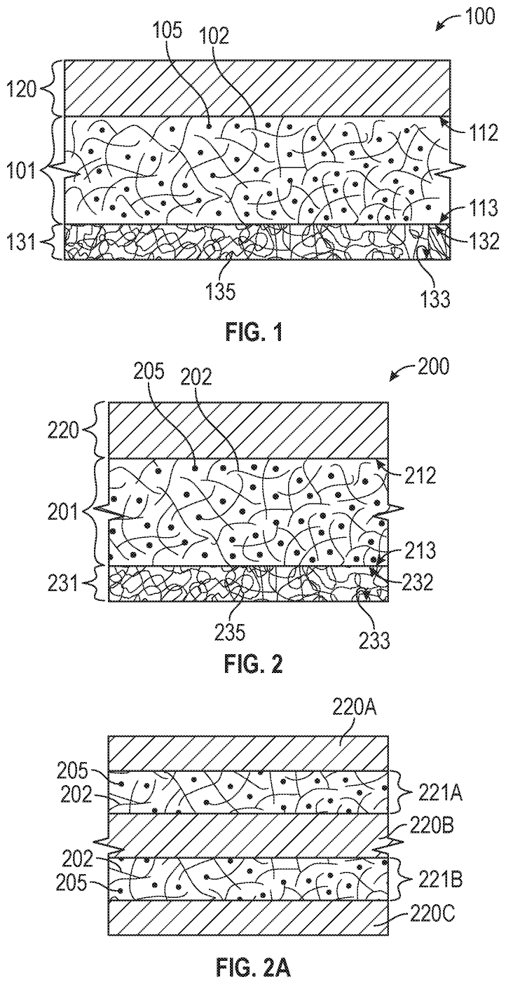

Referring to FIG. 2, exemplary biodegradable layered composite 200 comprises first nonwoven biodegradable layer 201 having first and second major surface 212, 213, biodegradable polymer film 220 on at least a portion of first major surface 212 of first nonwoven biodegradable layer 201, and optional degradable layered composite 200 further comprises second nonwoven biodegradable layer 231 having first and second major surface 232, 233. First nonwoven biodegradable layer 201 comprises biodegradable polymeric melt-blown fibers 202 and plurality of particles 205 enmeshed in biodegradable polymeric melt-blown fibers 202. Optional second nonwoven biodegradable layer 231 comprises spunbond fibers 235 on second major surface 213 of first nonwoven biodegradable layer 201. Film 220 is present as sections 220A, 220B, 220C with spaces 221A and 221B.

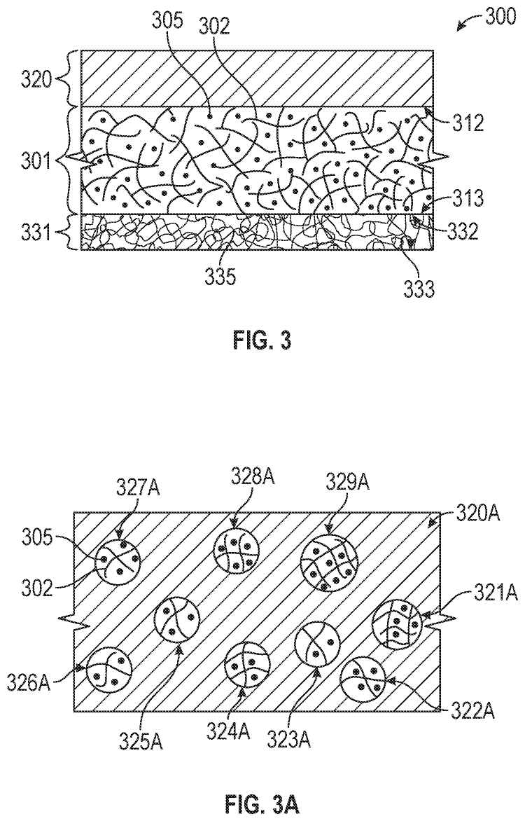

Referring to FIG. 3, exemplary biodegradable layered composite 300 comprises first nonwoven biodegradable layer 301 having first and second major surface 312, 313, biodegradable polymer film 320 on at least a portion of first major surface 312 of first nonwoven biodegradable layer 301, and optional degradable layered composite 300 further comprises second nonwoven biodegradable layer 331 having first and second major surface 332, 333. First nonwoven biodegradable layer 301 comprises biodegradable polymeric melt-blown fibers 302 and plurality of particles 305 enmeshed in biodegradable polymeric melt-blown fibers 302. Optional second nonwoven biodegradable layer 331 comprises spunbond fibers 335 on second major surface 313 of first nonwoven biodegradable layer 301. Film 320 is present as section 320A, with spaces 321A, 322A, 323A, 324A, 325A, 326A, 327A, 328A and 329A.

Biodegradable layered composites such as shown in FIGS. 2 and 3 can facilitate rain water and/or overhead irrigation water to drain to the soil underneath the mulch. This approach can decrease dependence on drip tape irrigation as the only source of irrigation to the soil underneath the mulch. It can also promote breathability of soil through the sections free of the film.

In some embodiments, there are in a range of 2 to 25 (in some embodiments, in a range from 5 to 25, 10 to 25, or even 15 to 25) sections along the length of the biodegradable layered composite. In some embodiments, the sections have a width in a range of 2 to 75 (in some embodiments, in a range from 2 to 50, 2 to 25, 3 to 10, or even 3 to 7) cm. In some embodiments, the sections have spaces therebetween, and wherein each space is in a range of 0.5 to 50 (in some embodiments, in a range from 0.5 to 25, 1 to 10, or even 1 to 5) cm.

In some embodiments, biodegradable layered composites described herein in use face the ground, although it can also be used where the composite faces the opposite direction.

For many agricultural applications, substantially uniform distribution of particles throughout the nonwoven biodegradable layer may be advantageous so that as particles are added evenly to the soil as they compost and enrich it. Gradients through the depth or length of the nonwoven biodegradable layer are possible, however, if desired.

Biodegradable layered composites described herein are effective for moisture uptake due to the tortuous porosity of the fabric combined, in some embodiments, with particles capable of moisture absorption. This attribute of the biodegradable layered composites is particularly useful to crop growers dependent on overhead sprinkler irrigation or rainfall to meet crop water demands. In some embodiments, biodegradable layered composites described herein have a moisture uptake of up to 670% on a weight basis.

In some embodiments, biodegradable layered composites described herein are opaque to minimize light transmittance and improve weed control. The biodegradable layered composite may be reflective, absorptive, light scattering or any combination thereof. For example, carbon black or titanium dioxide can be compounded into the polymeric material used to make the biodegradable layered composites resulting in a black or white biofabric respectively.

In some embodiments, the biodegradable layered composites described herein optionally further comprise additives such as at least one of seeds, fertilizer, weedicide, pesticide, or herbicide.

Biodegradable layered composite described herein can be provided, for example, as sheets or rolls. A roll of the biodegradable layered composite may be provided on a core that can be mounted on a tractor or other laying machine for application onto the field. One application process includes laying out rolls of biodegradable layered composite on the soil surface, providing or punching openings through the biodegradable layered composite and planting seeds or seedlings in the openings. Crops grow through the openings. For some application processes, such as manual application, it can be preferable for the biodegradable layered composite to be hand tearable in the cross-web direction.

In some embodiments, the presence of the film in biodegradable layered composites described herein improves the tear strength of the composite.

In some embodiments, the presence of the film in biodegradable layered composites described herein improves the puncture resistance of composite.

In some embodiments, the particle loaded biodegradable layered composite shields the film from effects of flying debris caused by windy conditions in a crop field.

In some embodiments, a water absorptive layer (i.e., particle loaded layer) can be present on the film backing to aid in reducing rain water run-off and splashing against the mulch, which in turn can decrease soil erosion in areas not covered by the mulch.

### Exemplary Embodiments

1. A biodegradable layered composite comprising:

a first nonwoven biodegradable layer having a first and second major surface, the first nonwoven biodegradable layer comprising:
biodegradable polymeric melt-blown fibers, and
a plurality of particles enmeshed in the biodegradable polymeric melt-blown fibers; and

a biodegradable polymer film on at least a portion of the first major surface of the first nonwoven biodegradable layer. In some embodiments, the biodegradable polymer film covers at least 25 (in some embodiments, at least 30, 35, 40, 45, 50, 55, 60, 65, 70, 75, 80, 85, 90, 95, 96, 97, 98, 99, or even 100) percent of the first major surface of the first nonwoven biodegradable layer.
2. The biodegradable layered composite of Exemplary Embodiment 1, wherein the biodegradable polymer film comprises at least one of polylactide (PLA), polybutylene succinate (PBS), naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).
3. The biodegradable layered composite of any preceding Exemplary Embodiment, wherein melt-blown fibers comprise at least one of polylactide (PLA), polybutylene succinate (PBS), naturally occurring zein, polycaprolactone, cellulosic ester, polyhydroxyalkanoate (PHA) (e.g., poly-3-hydroxybutyrate (PHB), polyhydroxyvalerate (PHV), or polyhydroxyhexanoate (PHH)).
4. The biodegradable layered composite of any preceding Exemplary Embodiment, wherein the biodegradable polymeric melt-blown fibers have an average fiber diameter in a range from 1 to 50 (in some embodiments, in a range from 1 to 40, 1 to 30, 1 to 20, 1 to 15, or even 1 to 10) micrometers.
5. The biodegradable layered composite of any preceding Exemplary Embodiment, wherein the ratio of average particle diameter to average melt-blown fiber diameter is in a range from 160:1 to 5:1 (in some embodiments, in a range from 150:1 to 5:1, 125:1 to 5:1, 100:1 to 5:1, 75:1 to 5:1, 50:1 to 5:1, 25:1 to 5:1, or even 15:1 to 5:1).
6. The biodegradable layered composite of any preceding Exemplary Embodiment, wherein at least 50 (in some embodiments, at least 60, 70, 75, 80, 85, 90, 95, 99, or even at least 100) percent by weight, based on the total weight of particles, of the particles comprise (in some embodiments, comprise at least 50, 60, 70, 75, 80, 85, 90, 95, 99 or even at least 100 percent by weight, based on the total weight of the respective particle) at least one of agricultural waste or forestry waste.
7. The biodegradable layered composite of Exemplary Embodiment 6, wherein the particles are at least one of rice hulls, wood flour, starch flakes, bug flour, soy meal, alfalfa meal, or biochar.
8. The biodegradable layered composite of any preceding Exemplary Embodiment, wherein at least 50 (in some embodiments, at least 60, 70, 75, 80, 85, 90, 95, 99, or even at least 100) percent by weight, based on the total weight of particles, of the particles comprise (in some embodiments, comprise at least 50, 60, 70, 75, 80, 85, 90, 95, 99 or even at least 100 percent by weight, based on the total weight of the respective particle) inorganic material.
9. The biodegradable layered composite of Exemplary Embodiment 8, wherein the particles comprise at least one of lime, gypsum, sand, clay, or vermiculite.
10. The biodegradable layered composite of any preceding Exemplary Embodiment, wherein at least 50 (in some embodiments, at least 60, 70, 75, 80, 85, 90, 95, 99, or even at least 100) percent by weight, based on the total weight of particles, comprise (in some embodiments, comprise at least 50, 60, 70, 75, 80, 85, 90, 95, 99 or even at least 100 percent by weight, based on the total weight of the respective particle) at least one of turkey waste, feather meal, or fish meal.
11. The biodegradable layered composite of Exemplary Embodiment 10, wherein at least 50 (in some embodiments, at least 60, 70, 75, 80, 85, 90, 95, 99, or even 100) percent by weight, based on the total weight of particles, of the particles contain nitrogen.
12. The biodegradable layered composite of any preceding Exemplary Embodiment, wherein the particles are in a range from 20 mesh to 60 mesh (in some embodiments, in a range from 25 mesh to 35 mesh).
13. The biodegradable layered composite of any preceding Exemplary Embodiment, wherein the particles are present in the biodegradable layered composite in a range from 1 to 85 (in some embodiments, in a range from 10 to 80, 25 to 80, 25 to 75, or even 50 to 60) percent by weight, based on the total weight of the biodegradable layered composite.
14. The biodegradable layered composite of any preceding Exemplary Embodiment further comprising a second nonwoven biodegradable layer comprising spunbond fibers on the second major surface of the first nonwoven biodegradable layer.
15. The biodegradable layered composite of Exemplary Embodiment 14, wherein the spunbond fibers comprise at least one of polylactide (PLA), polybutylene succinate (PBS), naturally occurring zein, polycaprolactone, cellulosic ester, polyhydroxyalkanoates (PHA) (e.g., poly-3-hydroxybutyrate (PHB), polyhydroxyvalerate (PHV), or polyhydroxyhexanoate (PHH)).
16. The biodegradable layered composite of either Exemplary Embodiment 14 or 15, wherein the spunbond fibers have an average fiber diameter in a range from 10 to 50 (in some embodiments, in a range from 10 to 40, 10 to 30, 10 to 25, 10 to 20, or even 10 to 15) micrometers.
17. The biodegradable layered composite of any of Exemplary Embodiments 14 to 16, wherein the second nonwoven biodegradable layer has an average thickness in a range from 10 to 3000 (in some embodiments, in a range from 10 to 2000, 10 to 1000, 10 to 500, 10 to 100, or even 10 to 50) micrometers.
18. The biodegradable layered composite of any preceding Exemplary Embodiment having a basis weight in a range from 60 g/m² to 300 g/m².
19. The biodegradable layered composite of any preceding Exemplary Embodiment, wherein the melt-blown fibers comprise carbon black.
20. The biodegradable layered composite of any preceding Exemplary Embodiment, wherein the first nonwoven biodegradable layer has an average thickness in a range from 10 to 3000 (in some embodiments, in a range from 10 to 2000, 10 to 1000, 10 to 500, 10 to 100, or even 10 to 50) micrometers.
21. The biodegradable layered composite of any preceding Exemplary Embodiment that is opaque.
22. The biodegradable layered composite of any preceding Exemplary Embodiment, wherein the film comprises carbon black.
23. The biodegradable layered composite of Exemplary Embodiment 22, wherein the film comprises at least 0.5 (in some embodiments, at least 1) percent by weight of the carbon black, based on the total weight of the film.
24. The biodegradable layered composite of any preceding Exemplary Embodiment, having a moisture uptake of up to 670% on a weight basis.
25. The biodegradable layered composite of any preceding Exemplary Embodiment, wherein the film has a plurality of openings.
26. The biodegradable layered composite of Exemplary Embodiment 25, wherein the openings are present in a range from 0.5 to 2000 (in some embodiments, in a range from 0.5 to 1000, 0.5 to 500, 0.5 to 100, 1 to 50, 1 to 25, or 1 to 10, or even 1 to 5) mm².
27. The biodegradable layered composite of Exemplary Embodiment 26, wherein the openings have at least one of the following shapes: a circle, a square, a rectangle, a triangle, or an oval.
28. The biodegradable layered composite of either Exemplary Embodiment 25 or 26, wherein the openings have an areal density in a range from 10 to 50 (in some embodiments, in a range from 15 to 40) per cm².
29. The biodegradable layered composite of any preceding Exemplary Embodiment having a length and a width, wherein the film is in the form of sections along the length of the biodegradable layered composite with areas between the sections free of the film.
30. The biodegradable layered composite of Exemplary Embodiment 29, wherein there are in a range of 2 to 25 (in some embodiments, in a range from 5 to 25, 10 to 24, or even 15 to 25) sections along the length of the biodegradable layered composite.
31. The biodegradable layered composite of either Exemplary Embodiment 29 or 30, wherein the sections have a width in a range of 2 to 75 (in some embodiments, in a range from 2 to 50, 2 to 25, 3 to 10, or even 3 to 7) cm.
32. The biodegradable layered composite of any of Exemplary Embodiments 29 to 31, wherein the sections have spaces therebetween, and wherein each space is in a range of 0.5 to 50 (in some embodiments, in a range from 0.5 to 25, 1 to 10, or even 1 to 5) cm.
33. The biodegradable layered composite of any preceding Exemplary Embodiment, wherein the first nonwoven biodegradable layer further comprises a biodegradable plasticizer.
34. The biodegradable layered composite of Exemplary Embodiment 33, wherein the biodegradable plasticizer comprises at least one of a renewable ester, epoxidized soybean oil, or acetyltri-n-butyl citrate.
35. The biodegradable layered composite of any preceding Exemplary Embodiment, wherein the biodegradable polymer film comprises a biodegradable plasticizer.
36. The biodegradable layered composite of Exemplary Embodiment 35, wherein the biodegradable plasticizer of the biodegradable polymer film comprises at least one of a renewable ester, epoxidized soybean oil, or acetyltri-n-butyl citrate.
37. The biodegradable layered composite of any preceding Exemplary Embodiment provided as a roll.

Objects and advantages of this invention are further illustrated by the following examples, but the particular materials and amounts thereof recited in these examples, as well as other conditions and details, should not be construed to unduly limit this invention.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Mo., or may be synthesized by known methods. Table 1, below, lists materials used in the Examples and their sources.

TABLE 1

| Designation | Description | Source |
|---|---|---|
| PLA1 | Polylactic acid obtained under | NatureWorks, LLC, |
| | the trade designation “INGEO | Minnetonka, MN |
| | BIOPOLYMER 6252D” | |
| PLA2 | Polylactic acid obtained under | NatureWorks, LLC |
| | the trade designation “INGEO | |
| | BIOPOLYMER 4032D” | |
| Carbon | Carbon black pigment | Clariant Corporation, |
| black | | Minneapolis, MN |
| Wood | Wood, 40 mesh, obtained under | American Wood |
| | the trade designation “AWF | Fibers, Schofield, WI |
| | MAPLE 4010” | |
| Rice hulls | Unground rice hulls, used as | Riceland Foods, Inc., |
| | supplied | Stuttgart, AR |
| PBS | Bio derived poly butylene | PTT MCC BioChem |
| | succinate, obtained under | Co., Ltd, Bangkok, |
| | the trade designation | Thailand |
| | “BIOPBS FZ71” | |
| PLA3 | Polylactic acid, obtained | NatureWorks, LLC |
| | under the trade designation | |
| | “INGEO BIOPOLYMER 6202D” | |

### Comparative Example A (CE-A)

Biodegradable layered composite Comparative Example A was prepared as follows. Biodegradable polylactic acid resin PLA1 (“INGEO BIOPOLYMER 6252D”), was melt-blown using an apparatus as shown in FIG. 6 of U.S. Pat. Pub. No. 2006/0096911 (Brey et al.), the disclosure of which is incorporated herein by reference. A pre-compounded polymeric master-batch comprising carbon black pigment and PLA2 (“INGEO BIOPOLYMER 4032D”) in a 10:90 weight ratio was obtained under the trade designation “XMB” from Clariant Corporation, Minneapolis, Minn. This masterbatch was dry blended with PLA1 “INGEO BIOPOLYMER 6252D” in a 10:90 weight ratio and fed into a single screw extruder (obtained as Model 258524 from Prodex, Gellainville, France) via a feeder (obtained under the trade designation “MAGUIRE WSB-200” from Maguire Product, Inc., Aston, Pa.). The resulting melt stream (90 wt. % PLA1 and 10 wt. % “XMB”) that exited the extruder die was 90 wt. % PLA1, 9 wt. % PLA2 and 1 wt. % carbon black.

The particles (see Table 2, below, for particle type and amount) were dropped directly onto the molten fibers exiting the extruder die using a vibratory feeder (obtained under the trade designation “MECHATRON” from Schenck AccuRate, Fairfield, N.J.) attached to melt blowing equipment (as generally described in U.S. Pat. No. 7,828,969 (Eaton et al.), the disclosure of which is hereby incorporated by reference) causing the particles to become captured and enmeshed in the molten polymer fibers.

TABLE 2

| | | | Basis weight, g/m² |
|---|---|---|---|
| | | | Film/BMF/particle/ |
| Example | Resin | Particle | scrim/total |
| CE-A | 90 wt. % PLA1, 9 wt. % | Wood | 0/20/66/30/116 |
| | PLA2, 1 wt. % carbon black | | |
| CE-B | 90 wt. % PLA1, 9 wt. % | Rice | 0/20/46/30/96 |
| | PLA2, 1 wt. % carbon black | Hulls | |
| CE-C | 90 wt. % PLA1, 9 wt. % | Rice | 0/78/208/30/316 |
| | PLA2, 1 wt. % carbon black | Hulls | |
| EX-1 | 90 wt. % PLA1, 9 wt. % | Wood | 30/20/66/30/146 |
| | PLA2, 1 wt. % carbon black | | |
| EX-2 | 90 wt. % PLA1, 9 wt. % | Rice | 30/20/46/30/126 |
| | PLA2, 1 wt. % carbon black | Hulls | |
| EX-3 | 90 wt. % PLA1, 9 wt. % | Rice | 30/78/208/30/346 |
| | PLA2, 1 wt. % carbon black | Hulls | |

The resulting material was sprayed onto a 30-g/m² spunbond scrim of PLA3 (“INGEO BIOPOLYMER 6202D”). The scrim was made using an apparatus as shown in FIG. 1 of U.S. Pat. No. 8,802,002 (Berrigan et al.), the disclosure of which is incorporated herein by reference. The combined roll of blown micro fiber (BMF)/particles cast onto a spunbond scrim was then passed between a pair of smooth calendar rolls to flatten and bond the composite fabric. In Comparative Example A, wood fiber (“AWF MAPLE 4010”) was used, resulting in a biodegradable layered composite of basis weight film/BMF/particle/scrim/total=0/20/66/30/116 g/m² as shown in Table 2, above.

### Comparative Example B (CE-B)

Biodegradable layered composite Comparative Example B was prepared as described for Comparative Example A, except that rice hulls were used as the particles. The biodegradable layered composite had a basis weight film/BMF/particle/scrim/total=0/20 g/m²/46 g/m²/30 g/m²/96 g/m² as shown in Table 2, above.

### Comparative Example C (CE-C)

Biodegradable layered composite Comparative Example C was prepared as described for Comparative Example A, except that rice hulls were used as the particles. The biodegradable layered composite had a different basis weight film/BMF/particle/scrim/total=0/78/208/30/316 g/m² as shown in Table 2, above.

### Example 1 (EX-1)

The biodegradable layered composite of Example 1 was prepared as described for Comparative Example A, with the addition, in a separate step, of a melt extruded thin film of PBS (“BIOPBS FZ71”) onto the BMF/particle side of the biodegradable layered composite. This was accomplished using a 58-millimeter (mm) twin screw extruder (obtained under the trade designation “DTEX58” from Davis-Standard, Pawcatuck, Conn.), operated at a 260° C. extrusion temperature, with a heated hose (260° C.) leading to a 760 mm drop die (obtained from Cloeren, Orange, Tex.) with 686 mm deckles: 0-1 mm adjustable die lip, single layer feed-block system. PBS resin was fed at a rate of 50 pounds per hour (22.7 kilograms per hour) into the twin screw system at the conditions described above. The resultant molten resin formed a thin sheet as it exited the die and was cast onto the BMF/particle side of the biodegradable layered composite. This biodegradable layered composite (with a cast film on one side) was fed into a nip assembly consisting of a plasma coated casting roll (150 roughness average; obtained from American Roller, Union Grove, Wis.) against the cast film side, and a silicon rubber nip roll (80-85 durometer; from American Roller) was against the spunbond side. The layered composite was pressed between the two nip rolls with a nip force of about 70 Kilopascals (KPa), at a line speed of 23 meters per minute. The biodegradable layered composite had a basis weight film/BMF/particle/scrim/total=30/20/66/30/146 g/m² as shown in Table 2, above.

### Example 2 (EX-2)

The biodegradable layered composite with a biodegradable polymer film of Example 2 was made as described for Example 1, except that Comparative Example B was used as the non-woven composite. The resulting basis weight was film/BMF/particle/scrim/total=30/20/46/30/126 g/m² as shown in Table 2, above.

### Example 3 (EX-3)

The biodegradable layered composite of Example 3 was made as described for Example 1, except that Comparative Example C was used as the non-woven composite. The resulting basis weight was film/BMF/particle/scrim/total=30/78//208/30/346 g/m² as shown in Table 2, above.

### Test Methods

### Water Uptake Test

A pair of scissors was used to cut a rectangular piece of prepared biodegradable layered composite. The samples were cut to the following dimensions: 18 centimeters (cm)×19 centimeters and their initial weight measured and recorded. Each dry sample was then tightly secured to the open mouth of an empty 400 milliliter (mL) glass beaker (obtained from Thermo Fisher Scientific Inc., Minneapolis, Minn.) using an elastic band. For the beaker covered with a Comparative Example sample, the spunbond side was facing out; while for the beaker covered with an Example sample, the cast film was facing out. The two covered glass beakers were placed upside down, in an aluminum pan measuring 25.4 cm×20.3 cm×6.4 cm, containing 775 grams of water, such that the biodegradable layered composites were partially submerged in the water. The samples were then left in this position to soak for 12 hours.

After 12 hours, each glass beaker was removed from the water and each biodegradable layered composite was carefully removed by loosening the elastic band that had held it in place. Each biodegradable layered composite was held in a vertical position above the tray for 30 seconds to reduce water dripping from the sample, and immediately set on a weighing balance to record the new weight. Results are shown in Table 3, below.

TABLE 3

| | | | | Dry | After | Water |
|---|---|---|---|---|---|---|
| | Basis weight, g/m² | Particle | Polymer | weight, | 12-hr | gained, g |
| Example | Film/BMF/particle/scrim/total | type | resin | g | soak, g | (wt. %) |
| CE-A | 0/20/66/30/116 | Wood | 90 wt. % | 3.7 | 11.8 | 8.1 |
| | | | PLA1, 9 wt. % | | | (219%) |
| | | | PLA2, 1 wt. % | | | |
| | | | carbon black | | | |
| EX-1 | 30/20/66/30/146 | Rice | 90 wt. % | 6.1 | 14.09 | 7.99 |
| | | Hulls | PLA1, 9 wt. % | | | (131%) |
| | | | PLA2, 1 wt. % | | | |
| | | | carbon black | | | |

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

1. A biodegradable layered composite comprising:
a first nonwoven biodegradable layer having a first and second major surface, the first nonwoven biodegradable layer comprising:
biodegradable polymeric melt-blown fibers, and
a plurality of particles enmeshed in the biodegradable polymeric melt-blown fibers; and
a biodegradable polymer film on at least a portion of the first major surface of the first nonwoven biodegradable layer.

2. The biodegradable layered composite of claim 1, wherein the biodegradable polymer film covers at least 25 percent of the first major surface of the first nonwoven biodegradable layer.

3. The biodegradable layered composite of claim 1, wherein the biodegradable polymer film comprises at least one of polylactide, polybutylene succinate, naturally occurring zein, polycaprolactone, cellulosic ester, or polyhydroxyalkanoate.

4. The biodegradable layered composite of claim 1, wherein melt-blown fibers comprise at least one of polylactide, polybutylene succinate, naturally occurring zein, polycaprolactone, cellulosic ester, or polyhydroxyalkanoate.

5. The biodegradable layered composite of claim 1, wherein at least 50 percent by weight, based on the total weight of particles, of the particles comprise at least one of agricultural waste or forestry waste.

6. The biodegradable layered composite of claim 1, wherein the particles are present in the biodegradable layered composite in a range from 1 to 85 percent by weight, based on the total weight of the biodegradable layered composite.

7. The biodegradable layered composite of claim 1 further comprising a second nonwoven biodegradable layer comprising spunbond fibers on the second major surface of the first nonwoven biodegradable layer.

8. The biodegradable layered composite of claim 1 having a basis weight in a range from 60 g/m² to 300 g/m².

9. The biodegradable layered composite of claim 1, wherein the first nonwoven biodegradable layer has an average thickness in a range from 10 to 3000 micrometers.

10. The biodegradable layered composite of claim 1 having a moisture uptake of up to 670% on a weight basis.

11. The biodegradable layered composite of claim 1, wherein the film has a plurality of openings.

12. The biodegradable layered composite of claim 11, wherein the openings are present in a range from 0.5 to 2000 mm².

13. The biodegradable layered composite of claim 1 having a length and a width, wherein the film is in the form of sections along the length of the biodegradable layered composite with areas between the sections free of the film.

14. The biodegradable layered composite of claim 13, wherein the sections have spaces therebetween, and wherein each space is in a range of 0.5 to 50 cm.

15. The biodegradable layered composite of claim 1 provided as a roll.
